(19) United States
(12) Patent Application Publication
(10) Pub. No.: US 2017/0318462 A1
(43) Pub. Date: Nov. 2, 2017

(54) SECURE NETWORK ACCESS DEVICE AND METHOD

(71) Applicant: EMBERTEC PTY LTD, Dulwich SA (AU)

(72) Inventor: Andrew Murdoch, Dulwich (AU)

(21) Appl. No.: 15/152,663

(22) Filed: May 12, 2016

(30) Foreign Application Priority Data
Apr. 28, 2016 (AU) 2016202740

(51) Int. Cl. H04W 12/06; H04L 29/06; H04L 29/08; H04W 84/12

(52) U.S. Cl. CPC H04W 12/06; H04L 67/12; H04L 63/083; H04L 63/0876; H04W 84/12

(57) ABSTRACT

A network connected device adapted to support both a secure wi-fi connection to a secured network and a temporary insecure wi-fi connection to an unsecured network, wherein the unsecured network connection is used to collect configuration data from a user to enable creation of the secured network connection. Information concerning any failure to establish the secure connection is communicated to the user. The device does not include an integrated physical user interface capable of collecting the configuration data.

### FIELD OF THE INVENTION

The invention relates to a method and device for securely communicating configuration data and the outcome of connection attempts when establishing a network connection.

### BACKGROUND OF THE INVENTION

The following references to and descriptions of prior products and other developments are not intended to be, and are not to be construed as, statements or admissions of common general knowledge in the art. In particular, the following discussion does not relate to what is commonly or well known by the person skilled in the art, but may assist in the understanding of the invention, of which the identification of pertinent prior developments is but one part.

There is currently world-wide concern about the level of use of electrical energy for both domestic and commercial uses. In part this concern is based on the greenhouse gas production associated with the generation of electrical energy, and the contribution of that greenhouse gas to anthropogenic global warming. There is also a concern for the capital cost involved in building the electricity generating plants and electricity distribution networks required to generate and distribute an increasing amount of electricity.

Information concerning the usage patterns and energy usage of plug loads is difficult to obtain, but has become very important to energy supply and distribution utilities, as well as to householders.

Such information may be available from “Internet of Things” devices, but this may need to be transmitted from households, or among devices in a household, via secured networks for analysis.

In general, effective means of connecting Internet of Things devices securely to existing secured networks are desirable to allow analysis of the data available to Internet of Things devices, and to permit secure remote control of such Internet of Things devices.

### SUMMARY OF THE INVENTION

One aspect of the invention involves a network connected device adapted to support a secure wi-fi connection to a secured network, and a temporary insecure wi-fi connection to an unsecured network, wherein the unsecured network connection is used to collect configuration data from a user, with the configuration data enabling creation of the secured network connection.

Preferably, information concerning a failure of the secure connection to be established is communicated to the user.

The device does not include an integrated physical user interface capable of collecting the configuration data.

Preferably the device includes a web server, with the web server serving a web page which is accessible only from the unsecured network.

Preferably, there is a network manager adapted to create the secure connection to the secured network, and a database adapted to store a result of each attempt by the network manager to create the secure connection, wherein the network manager writes the result to the database, and the web server makes the result available to the user.

Preferably, the configuration data includes the Service Set Identifier (SSID) of the secured network, the security protocol of the secured network, and a valid password for the secured network.

Preferably the device is a household energy monitoring hub, or a standby power controller.

The invention also involves a method for connecting a device adapted to be connected to a secured network to a secured network, the method including the steps of:

establishing a temporary unsecured network, wherein a user connects to the unsecured network from a device with a user interface;

collecting configuration data of an existing secured network from the user via the user interface over the unsecured network;

creating a secure connection from the device to the secured network using the configuration data; and

shutting down the temporary unsecured network.

Preferably, the method further includes the steps of serving a web page to the unsecured network where the user enters the configuration data;

the web server receiving the result of each attempt to create the secure connection; and reporting the result to the user via the web page.

### BRIEF DESCRIPTION OF THE DRAWINGS

Exemplary versions of the invention will now be discussed with reference to the accompanying drawings, wherein:

FIG. 1 is a representation of a prior art method of connection to a network.

FIG. 2 is a representation of a further prior art method of connection to a network.

FIG. 3 is a diagrammatic representation of a network topology including a device including an embodiment of the current invention.

FIG. 4 shows a block diagram of network connection operation of a device incorporating the current invention.

FIG. 5 is a flowchart of a network connection in an exemplary version of the invention.

FIG. 6 shows the installation of an appliance including an embodiment of the current invention in the form of a standby power controller (SPC) in a household.

FIG. 7 shows an embodiment of the current invention utilizing a household energy monitoring hub.

### DETAILED DESCRIPTION OF EXEMPLARY VERSIONS OF THE INVENTION

Wi-fi networks are now widespread in households. These networks allow wireless enabled devices within the household to access a local network of connected devices, and potentially to communicate with these connected devices. Further, there is usually provided on the network a gateway which provides access to a wide area network or the internet.

The wi-fi network was historically designed to be accessed by devices such as portable computers, which include a fully functional user interface allowing text and/or graphical based interaction. Accordingly, authentication to such networks, when secured, has used text based passwords. Conventionally, when a device wishes to connect to a secured network, an attempt is made to connect. This attempt is met with a challenge from the network. In order to pass the challenge, a user, using the user interface of the device, provides a password. If the password is recognized by the network, a connection is established and access to the network is granted.

There are an increasing number of appliances and similar devices which require network connectivity, or are at least capable of network connectivity. These devices form part of the “Internet of Things”, the connection of devices which are not general purpose computers to a local or wide area network. These devices are characterized in that they are not general purpose computers, are often small, and do not have—and often cannot economically or practically have—a full featured text or graphic user interface.

Such appliances may include, without limitation, washing machines, dishwashers, cooking appliances, security sensors, energy monitoring sensors, controllable plug load switches, household energy monitoring hubs, security hubs, and many other devices.

The lack of a suitable user interface makes the conventional password approach infeasible or impossible.

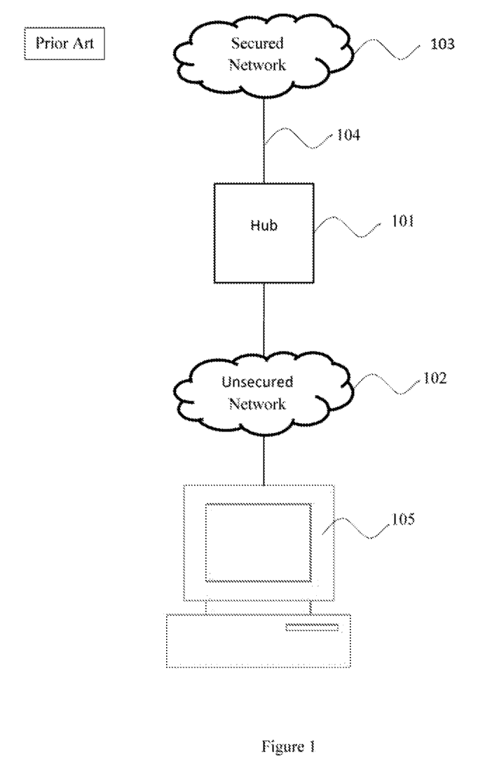

Referring first to FIG. 1, a prior art method of an appliance gaining access to a secured network is shown. An appliance, here a household energy monitoring hub 101, is shown with a secured wi-fi network 103. The secured wi-fi network 103 is the household network for the household in which the hub 101 is installed. The network 103 includes a modem/router which provides access to the public internet.

When the hub 101 is installed in the household it is necessary for the hub 101 to connect to the secured network 103 by creating a secure connection 104. In order to authenticate to the network so that the network will allow the creation of secure connection 104, the hub 101 must provide a password.

In order to collect the required password from a user, the hub 101 includes an unsecured network 102. This unsecured network 102 will accept connection from any network client. A user uses a device with a full text based user interface, PC 105, to access this unsecured network 102. The user then provides the required password to the hub 101, which is then used by the hub 101 to login to the secured network 103 and create connection 104. Should the login fail, the reason for the failure is readily transmitted to the user, who remains connected to the unsecured network 102. The success of the formation of connection 104 may also be conveyed to the user of the PC 105, who may then choose to, or be prompted to, break the connection to the unsecured network 102 from the PC 105.

This method of connection of the hub 101 to the secure network 103 creates a serious security risk for the secured network 103 in the form of the permanently active unsecured network 102.

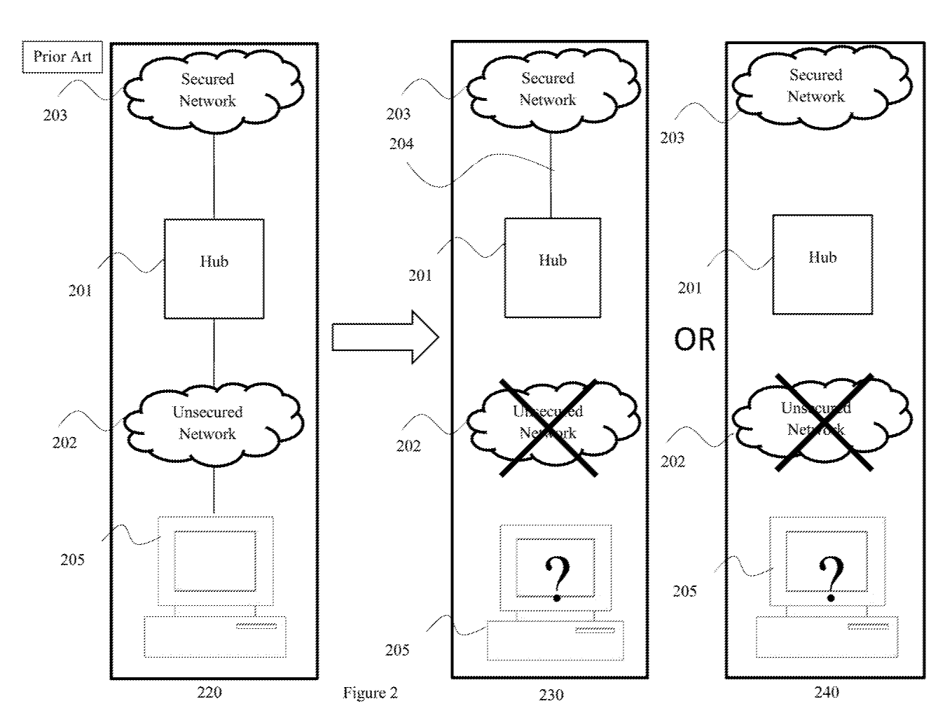

An alternative prior art method for supplying the required password is illustrated in FIG. 2. This attempts to address the problem of simultaneous connection by the hub 201 to both the secured network 203 and unsecured network 202.

An initial connection is shown in the leftmost box 220 of FIG. 2. Again, an appliance is shown in the form of a household energy monitoring hub 201 used in the vicinity of a secured wi-fi network 203. The secured wi-fi network 203 is the household network for the household in which the hub 201 is installed. The network 203 includes a modem/router which provides access to the public internet. The hub 201 requires connection to the network 203.

In order to authenticate to the network 203 the hub 201 must provide credentials, in the illustrated embodiment, a password. To collect the required password from a user, the hub 201 includes an unsecured network 202. This unsecured network 202 will accept connection from any network client. A user uses a device with a full text-based user interface, PC 205, to access this unsecured network 202. The user then provides the required password to the hub 201.

The hub 201 then attempts to connect to the secured network 203. The possible results of this attempt are shown in the central box 230 of FIG. 2 if the attempt is successful, or in the rightmost box 240 of FIG. 2 for an unsuccessful attempt.

In order to avoid the problem of simultaneous connection to a secured and an unsecured network, the hub 201 closes the unsecured network 202, severing the connection to the PC 205. The hub 201 then uses the previously collected password to login to the secured network 203, forming secure connection 204. The hub 201 is now correctly set up for normal operation. The success of the connection cannot be communicated directly to the user via PC 205, since there is now no connection between the hub and the PC 205.

Alternatively the connection attempt may fail, as illustrated in box 240. As before, in order to avoid the problem of simultaneous connection to a secured and an unsecured network, the hub 201 closes the unsecured network 202, severing the connection to the PC 205. The hub 201 then uses the previously collected password to attempt to login to secured network 203. When this attempt fails, the hub 201 has no network connection of any kind. The failure of the connection attempt cannot be directly communicated to the user via PC 205, since no connection exists between the hub 201 and the PC 205. The hub 201 is not correctly setup for normal use, and cannot readily communicate the reason for the connection attempt failure to the user to for example, seek correction of the password.

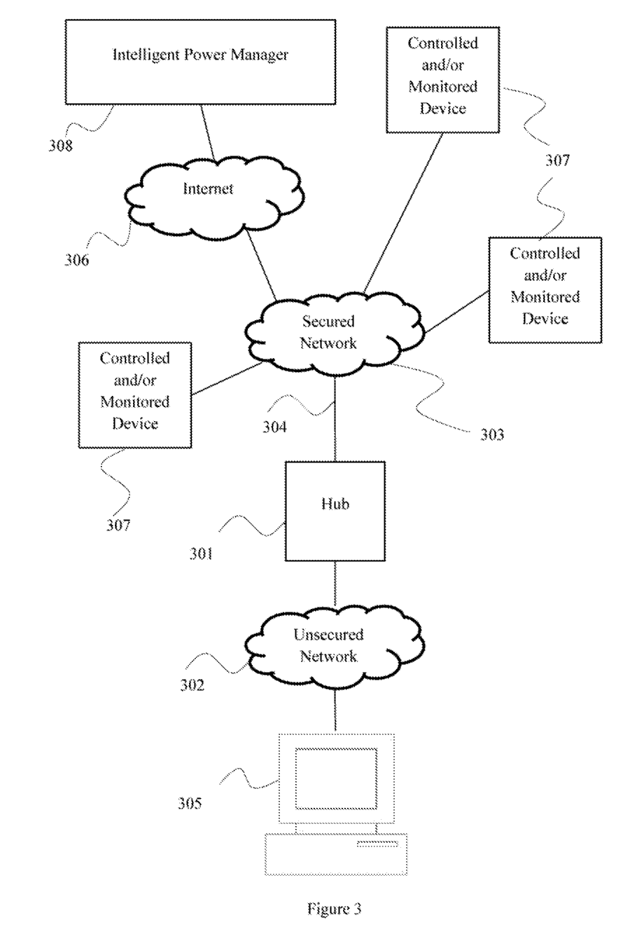

FIG. 3 is a diagrammatic representation of a network topology illustrating an exemplary version of the invention. It is to be understood that this is a general representation of an installation including the invention, and is illustrative only.

An appliance is provided in the form of a household energy monitoring hub 301, though the appliance may instead be a standby power controller, or another device forming part of the Internet of Things. A secured wi-fi network 303 is the household network for the household in which the hub 301 is installed. The network 303 includes a modem/router (not shown) which provides access to the public internet 306. The hub 301 requires access to the secured network 303.

The hub 301 does not have an integrated physical user interface. It does not have a keyboard and screen or any other means by which a user may enter text or commands directly into the hub. The hub 301 is a device which collects data from, and optionally controls at least some functions of, one or more connected devices 307. These devices may include, without limitation, electricity meters (Smartmeters), automated light switches and automated plug load switches. These connected devices 307 may be connected to the secured network 303 by wired or wireless connections. Alternatively or additionally, connected devices 307 may be connected to the hub 301 by alternate means such as a ZigBee connection. The hub 301 may communicate with the connected devices 307 via the secured network 303. In order to do this, the hub 301 must connect to the secured network 303 by creating secure connection 304. The hub 301 may also be adapted to be in communication with a remote Intelligent Power Manager (IPM) 308. The IPM 308 is typically remote from the household in which the hub 301 is installed, and communication to the IPM is via the public internet 306.

In order to connect to the secured network, the hub 301 requires configuration data. This configuration data may include, without limitation, the SSID of the secured network, the security protocol used by the secured network and a password which will be recognized by the secured network as permitting connection to the secured network. This configuration data is available from a user who has access to a computing device having a user interface and a wi-fi connection capability.

The hub 301 creates unsecured network 302. This unsecured network 302 has a predefined configuration which is public ally known. The information is provided as part of the setup instructions for the hub 301. The hub 301 acts as a wi-fi access point for the unsecured network 302. The hub 301 provides the services of router, DNS and DHCP server for the unsecured network 302. These services are restricted, such that the only routing possible is to the hub 301 and the only possible DNS lookup is the domain name of the hub 301.

The hub 301 broadcasts the SSID of the unsecured network. Preferably the SSID is a tag which is easily recognised by a user as being associated with the appliance being connected to the secured network.

There is computing device which includes a user interface capable of receiving text input, and which has a wi-fi capability. In the illustrated embodiment this is a PC 305 which a user uses to connect to the unsecured network 302. The user searches for the known SSID of the unsecured network 302, and connects to that network 302. The unsecured network 302 does not require a password, nor is the connection encrypted.

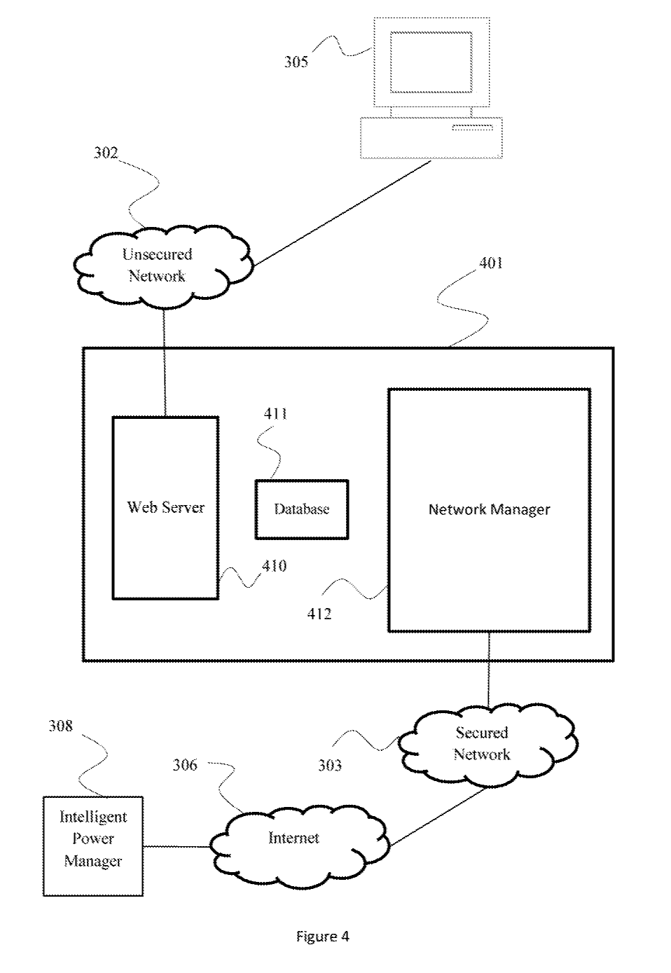

Turning now to FIG. 4, there is shown a block diagram of the network connection operation of the hub, here depicted at 401. The hub 401 includes a Network Manager 412 which creates the unsecured network 302. The network manager 412 acts as DNS, DHCP and router for the unsecured network 302.

The hub 401 includes a Web Server 410. The Web Server 410 is firewalled such that it will communicate only on the unsecured network 302.

A user uses a PC 305 to search for the SSID of the unsecured network 302. The user connects the wi-fi connector of the PC to the unsecured network. In most cases the PC 305 will already be connected to the secured network 303, since it is the wi-fi network of the household, and this connection to the unsecured network 302 will cause the connection to the secured network 303 to be dropped.

The user then opens a web browser on the PC 305 and loads a web page which is served by the Web Server 410. This page allows the user to supply the configuration data for the secured network 303. These data may include, without limitation, the SSID, the security protocol and a password.

Having received the configuration data, the Web Server 410 passes this to the Network Manager 412. The web page being displayed by the PC 305 then continuously polls the Web Server 410 for changes in the wi-fi connection status.

The Network Manager 412 uses the configuration data to attempt to connect to the secured network 303. The attempt to connect may succeed or it may fail. Failure to connect may be due to a number of reasons, including, without limitation:
a. The requested SSID is not found
b. The security protocol does not match
c. The password is incorrect
d. The router rejects connection attempts for other reasons. These may include MAC address filtering, which allows only devices with known MAC addresses to connect, being active on the secured network.
   The result of the connection attempt, including the reason for failure if failure occurs, is written to database 411 provided by the hub 301. The Web Server 410 interrogates the database 411 for the connection status. The connection status is then provided to the web page being displayed to the user via the PC 305. The user is thus aware of the success or failure of the attempt to connect to the secured network 303.

Where the attempt to connect to the secured network 303 has failed, the user can be informed of the reason for the failure via the web page. The web page then allows the user the opportunity to correct the configuration data, before a further attempt is made to connect to the secured network 303. For example, where an incorrect password has been supplied, the web page, having informed the user of the reason for the connection failure, will allow the user an opportunity to enter a different password. The modified password will then be passed to the network manager 412, which will make a further attempt to connect to the secured network 303. The result of this attempt will then be communicated to the database 411, and hence to the user via the webpage. This may apply to any element of the configuration data.

When the connection 304 is successfully established, this is notified to the database 411. The success notification is passed to the user via the web page being displayed by the PC 305. Upon successful connection, the web page shows instructions to the user to reconnect the PC 305 to the secured network 303, which was dropped when the PC connected to the unsecured network 302.

Upon communication of a successful connection, the hub 401, immediately or after a short delay (being two minutes, for example), will close down the unsecured network 302. In many cases this will be sufficient to cause the PC 305 to reconnect to the secured network 303. In other cases, the user may follow the previously given instructions to reconnect to the secured network 303.

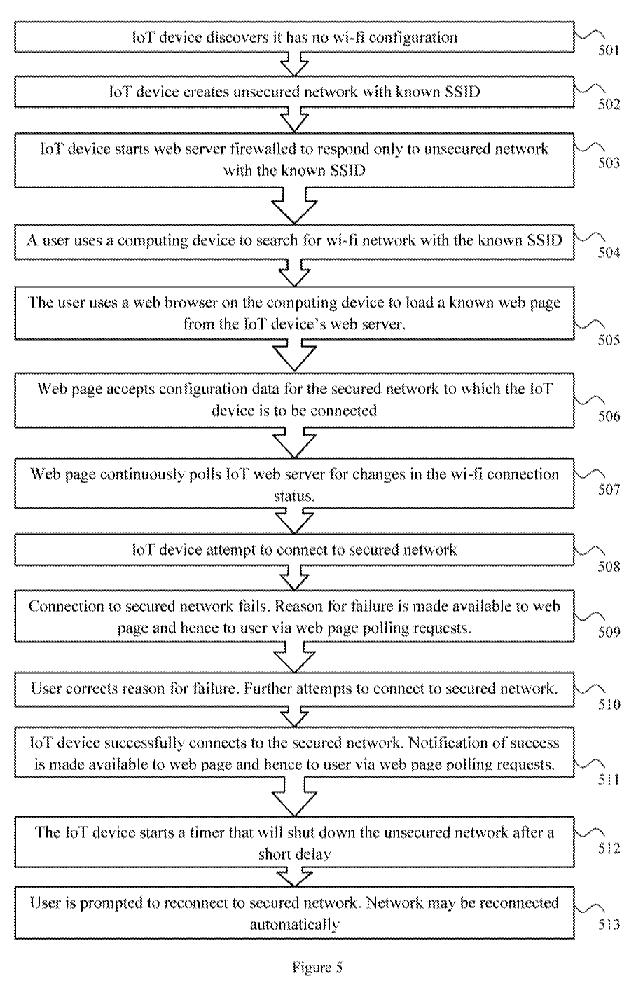

A flowchart of the connection of a general Internet of Things device to a secured network is shown in FIG. 5. The Internet of things (IoT) is to be connected to a local network. The IoT device has a wi-fi capability but does not include a physical user interface. At 501 the IoT device begins operating, and discovers that it has no valid wi-fi configuration.

At 502, the IoT device and creates an unsecured wi-fi network with itself as the router, DNS and DHCP server. This network has an easily recognized SSID, for example “hello”. The IoT device has a fixed IP address, for example 10.9.8.7 and known hostname, for example hello.local.

At 503, the IoT device starts a web server that is firewalled to only respond to the “hello” network.

There is a user attempting to set up the IoT device, and give the IoT device access to the secured network. At 504, the user uses a computing device to search for available local wi-fi networks and connects to the one named “hello”. The computing device may be, for example, a PC, a tablet computer or a smartphone. The computing device has a wi-fi networking capability and a user interface able to receive a password.

At 505 the user starts a web browser on the computing device and loads a page from the IoT device's web server (http://hello.local). This network is unsecured.

At 506, the web page allows the user to enter the details of the wi-fi network to which the IoT device is to be connected, including, without limitation, the SSID, security protocol, and password.

At 507 the web page continuously polls the IoT web server for changes in wi-fi connection status.

At 508, the IoT device attempts to connect to the secured wi-fi network, which can take several seconds.

The attempt to connect to the secured network may fail. The wi-fi connection may fail for reasons which include, without limitation:
a. The requested SSID is not found
b. The security protocol does not match
c. The password is incorrect
d. The router rejects connection attempts for other reasons (MAC address filtering, etc.)

At 509, in the event of failure to connect to the secured network, the reason for failure is recorded and made available to the web page and via its polling requests. The web page is displayed to the user, who is thus informed of the failure and the reason for the failure.

At 510, the user corrects the reason for the failure, for example by providing the correct password. A further attempt is made by the IoT device to connect to the secured network.

At 511 a successful wi-fi connection is recorded and made available to the web page via its polling requests. Where no failure of connection occurs, this step immediately follows step 508.

At 512, after a successful connection, the IoT device starts a timer that will shut down the “hello” network after a short delay. In a preferred embodiment, the delay is two minutes.

At 512, connection of the IoT device the secured network is complete, and the user has been notified of the success. The user is prompted to cause the computing device to re-join the secured network. Many computing devices will automatically connect to known networks when the “hello” network ceases to be available, thus re-joining the secured network without user intervention.

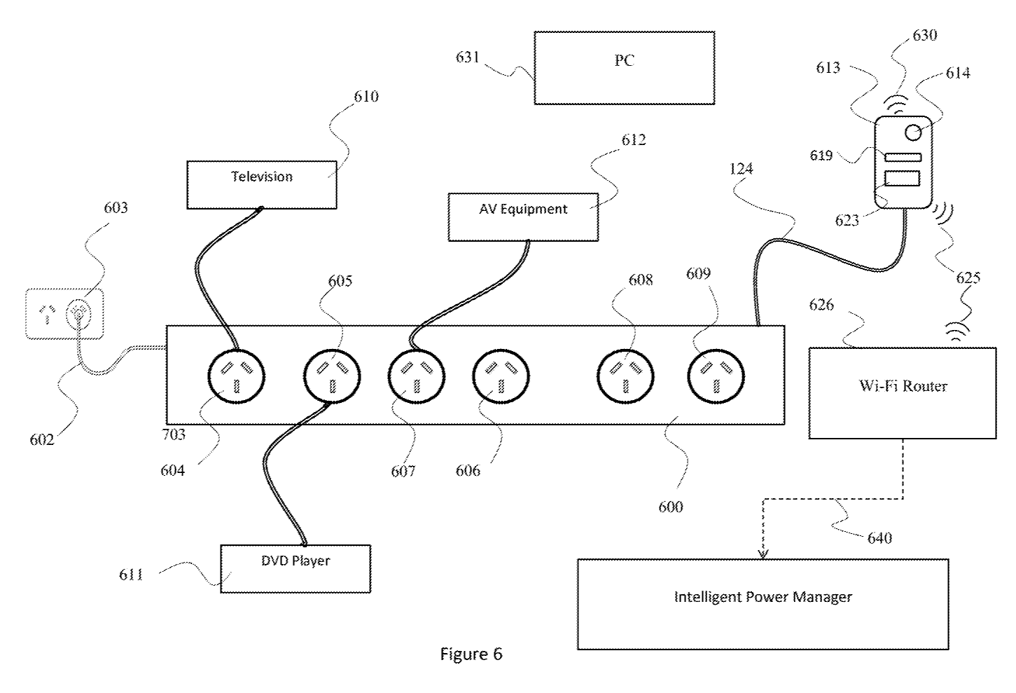

FIG. 6 shows the installation of an appliance in the form of a standby power controller (SPC) in a household. The standby power controller is an Internet of Things device, which includes a wi-fi networking capability. The standby power controller does not include a physical user interface. An SPC is an energy saving device which is installed between the mains power supply and an electrical device. For example, it is common that electrical devices such as AV equipment and computer equipment are “turned off” by being changed to a standby power state, which reduces, but does not eliminate, power consumption. Energy savings may be achieved by powering these types of devices by plugging them into an SPC. In some instances one of these attached electrical devices may be considered to be the main device, in that if the main device is off or in a standby state then all other devices, referred to as slave devices, attached to the SPC should be off. It may or may not be the case that power should also be withdrawn from the main device. In particular power may not be withdrawn where the main device is a computer.

In other cases, when a main device, for example a television, is in a standby state, it is desirable to remove power from the main device and any associated electrical devices. This is common where there is a subset of electrical devices such as televisions, video equipment, personal video recorders (digital video recorders), CD players, stereo systems, amplifiers, pay-television boxes and other AV equipment grouped into close proximity and often used in combination with each other.

The SPC 600 of FIG. 6 is adapted for use with AV equipment. The SPC 600 receives electrical power from a General Purpose Outlet 603, via power cord 602. The SPC 600 includes Monitored and Controlled Outlets 604, 605, 606, 607. The SPC 600 may also include Uncontrolled Outlets 608, 609. In general, any number of Monitored and Controlled outlets and Uncontrolled Outlets may be provided. In some versions, the Uncontrolled outlet(s) may be absent.

Monitored and Controlled Outlet 604 supplies electrical power to a television 610. Further Monitored and Controlled Outlets 605, 606 may provide electrical power to other audio-visual equipment, for example a DVD player 611 and audio equipment 612. In a version having only one Monitored and Controlled outlet, multiple devices may be powered from the one outlet using a powerstrip (and more generally, where one or more Monitored and Controlled outlets are present, multiple devices may be powered from each or any Monitored and Controlled outlet using a powerstrip).

The SPC 600 includes a Sensing and Communications Unit 613. Preferably, this Sensing and Communications Unit 613 is in data communication with the body of the SPC via cable 624, which may also provide power to the Sensing and Communications Unit 613. The cable 624 may be a fixed connection or may be plug connected at one or both ends. Alternatively, the cable may be replaced with any convenient wireless connection. As another alternative, the Sensing and Communications Unit may be integrated with the SPC body. The Sensing and Communications Unit 613 also includes a wi-fi transceiver 623.

Modern television sets and other audio visual equipment, when turned “off” by the remote control, enter a low power “standby” state in which energy is still consumed, although at a significantly lower level that when the device is nominally “on”. When the television is in this standby state it is not in use, and the power supply to it may be cut to save energy.

It is also the case that television sets may be left on for extended periods when no user is viewing the screen. This may happen when a user falls asleep in front of the television, or when a user, particularly a child or a teenager, simply leaves the vicinity of the television without turning the television off. This state may be termed “active standby”. In this state the television is not in use, and the power supply to it may be cut to save energy.

The SPC 600 may detect that the television has entered a standby state by any convenient means or combination of means. In order to save energy, the SPC 600 operates to remove the power supply from the Monitored and Controlled outlet 604, and hence from the attached television, whenever the television is detected to not be in use, whether in a low power standby state or an active standby state. Power may also be removed from all other Controlled outlets 605, 606, 607, since the devices powered through those outlets are in use only when the television is in use.

The SPC 600 includes a power sensor adapted to sense the power drawn through a Monitored and Controlled outlet 604, 605, 606, 607. The power sensor detects characteristics of the power flow through the outlet. When the characteristic is such as to indicate that the television is in a standby state, the power to the Monitored and Controlled outlet 604, and hence to the attached television or monitor, is interrupted.

The SPC 600 may include any number of Monitored and Controlled outlets 604, 605, 606, 607, which may be monitored and controlled individually or together.

The SPC 600 may include means to detect that a user is interacting with the audiovisual equipment and/or the television. As an example, the sensing and communications unit 613 includes an infra-red sensor 619. This sensor 619 receives IR signals from a remote control associated with the television or other connected AV equipment. It is likely that a user, when actively watching television, will periodically use the remote control to change channels, adjust volume, mute commercials, etc. Thus, a remote control signal receiver, such as IR sensor 619, can be used as a usage sensor. If no remote control activity is detected by the IR sensor 619 for a period of time, the assumption may be made that the television is not in use, and the power supply to the Monitored and Controlled outlet 604, and hence to the television, is interrupted. This may be achieved by using a countdown timer which starts from a specific initial value equal to a particular time period, say one hour, and having this countdown time continuously decrement. Each detected use of the remote control will reset the countdown timer to the initial value. When the countdown time reaches zero there has been no remote control activity for the time period and the television is therefore assumed to not be in active use, that is, to be in an active standby state. Thus, the electricity supply to the Monitored and Controlled outlet 604, and hence to the television, is interrupted. Preferably, the supply of electricity to all Monitored and Controlled Outlets 604, 605, 606, 607 is interrupted at the same time.

It may be sufficient to determine that a user is present in the vicinity of the television in order to decide that the television should not be turned off. Any suitable sensor may be used for determining that a user is present, and thus that power to the television should not be interrupted. These include, without limitation, passive IR sensors, ultrasonic sensors, cameras, any other passive or active movement sensors, and/or sound detectors.

Whatever means is used to determine that the television is on, but not in use, it is unlikely to be completely free of false positives, that is, determining that the television is in active standby and not in use when the television is in fact in use. If the television is turned off when a user is still watching a program, the user will be irritated. Repeated occurrences are likely to lead to the user's bypassing of the power control function of the SPC 600, preventing power savings.

The Sensing and Communications Unit 613 includes a warning LED 614. When the SPC 600 determines that the television is in active standby, the warning LED 614 will flash to alert any user to the imminent shutdown of the power to the television. In the case where there is a false positive, that is, there is a user watching the television, the user may react to observing the flashing of the warning LED 614 by pressing a key on the remote control. The IR signal from the remote control is detected by the IR sensor 619, and the countdown timer is reset, preventing the power to the television being interrupted. Other methods for warning of imminent shutdown of power to the television may be used, such as the sounding of an audible warning tone.

The SPC 600 may include software allowing control of the warning mechanism. The brightness of the LED 614 may be variable. It may be possible to set times when the warning should take certain forms. For example, an audible warning may be used at certain times of the day, while the LED may be used at other times, or both may be used together at given times. At still further times, no warning at all may be given.

Uncontrolled power outlets 608, 609 are optionally provided to allow for power to be supplied to devices which should not have the power supply cut when the television is not in use. These outlets supply power at all times when the SPC 600 is plugged in. Any number of uncontrolled outlets may be provided.

Devices other than a television may be connected along with a television to the

Monitored and Controlled outlets 604, 605, 606, 607. In this case, the total load of all devices will be monitored for the characteristics indicating that all devices so connected are in a standby or unused state.

The wi-fi transceiver 623 of the Sensing and Communications Unit 613 provides data link 625 to a secured wireless network provided by wi-fi router 626. The wi-fi router 626 is the household wi-fi router which provides the wi-fi network for wi-fi capable devices within the household, and provides access to the internet 640.

The SPC 600 communicates the raw data from the power sensor and the IR sensor 619, along with the timing of the switch control activity, via wi-fi router 626 which has a connection to the internet 640, to a remote Intelligent Power Manager 641. The Intelligent Power Manager 641 may then use this data to know the energy usage of the plug loads connected to the SPC 600 and estimate energy savings which are attributable to the installation of the SPC 600. Information concerning the usage patterns and energy usage of plug loads is difficult to obtain, but has become very important to energy supply and distribution utilities, as well as to householders.

Some or all of the analysis of the power drawn through the Monitored and Controlled outlets 604, 605, 606, 607 may be performed by the Intelligent Power Manager 641. The Intelligent Power Manager 641 may communicate instructions to the SPC 600 to control the Monitored and Controlled Outlets.

The SPC 600 does not have a physical user interface. When connected in a household, the SPC 600 must establish wi-fi link 625 to the secured network provided by router 626. In order to connect to the secured network, the SPC 600 requires configuration data for the secured network . This configuration data may include, without limitation, the SSID of the secured network, the security protocol used by the secured network, and a password which will be recognized by the secured network as permitting connection to the secured network. This configuration data is available from a user who has access to a computing device having a user interface and a wi-fi connection capability.

When the SPC 600 is first installed in a household, the Sensing and Communications Unit 613 creates unsecured network 630. This unsecured network 630 has a predefined configuration which is publicly known. The information is provided as part of the setup instructions for the SPC 600. The Sensing and Communications Unit 613 acts as a wi-fi access point for the unsecured network 630. The Sensing and Communications Unit 613 provides the services of a router, DNS and DHCP server for the unsecured network 630.

The SSID of the unsecured network 630 is broadcast. Preferably the SSID is a tag which is easily recognised by a user as being associated with the appliance being connected to the secured network.

A computing device, for example a PC 631, includes a user interface capable of receiving text input, and has a wi-fi capability, and is used by the user to connect to the unsecured network 630. The user searches for the known SSID of the unsecured network 630, and connects to that network. The unsecured network 630 does not require a password, nor is the connection encrypted.

The user uses the PC 631 to search for the SSID of the unsecured network 630. The user connects the wi-fi connector of the PC 631 to the unsecured network 630. In most cases the PC 631 will already be connected to the secured network, since it is the wi-fi network of the household, and this connection to the unsecured network 630 will cause the connection to the secured network to be dropped.

The user then opens a web browser on the PC 631 and loads a web page which is served by a web server provided by the Sensing and Communications Unit 613. This page allows the user to supply the configuration data for the secured network provided by the wi-fi router 626. These may include, without limitation, the SSID, the security protocol and a password.

Having received the configuration data, the Sensing and Communications Unit 613 uses the configuration data to attempt to connect to the secured network provided by the wi-fi router 626. The attempt to connect may succeed or it may fail. Failure to connect may be due to a number of reasons, including, without limitation:

a. The requested SSID is not found

b. The security protocol does not match

c. The password is incorrect

d. The router rejects connection attempts for other reasons.

The result of the connection attempt, including any reason for failure, is then provided to the web page being displayed to the user via the PC 631. The user is thus aware of the success or failure of the attempt to connect to the secured network provided by the wi-fi router 626.

Where the attempt to connect to the secured network has failed, the user can be informed of the reason for the failure via the web page. The web page then allows the user the opportunity to correct the configuration data before a further attempt is made to connect to the secured network. For example, where an incorrect password has been supplied, the web page, having informed the user of the reason for the connection failure, will allow the user an opportunity to enter a different password. The modified password will then be passed to the network manager which will make a further attempt to connect to the secured network. The result of this attempt will then be communicated to the Sensing and Communications Unit 613, and hence to the user via the webpage. This may apply to any element of the configuration data.

When the connection 625 is successfully established, this is notified to the Sensing and Communications Unit 613. The success notification is passed to the user via the web page being displayed by the PC 631.

Upon successful connection, the web page shows instructions to the user to reconnect the PC 631 to the secured network provided by the wi-fi router 626, which was dropped when the PC 631 connected to the unsecured network 630.

Upon communication of a successful connection, the Sensing and Communications Unit 613, immediately or after a short delay (for example, two minutes), will close down the unsecured network. In many cases this will be sufficient to cause the PC 631 to reconnect to the secured network provided by the wi-fi router 626. In other cases, the user may follow the previously given instructions to reconnect to the secured network.

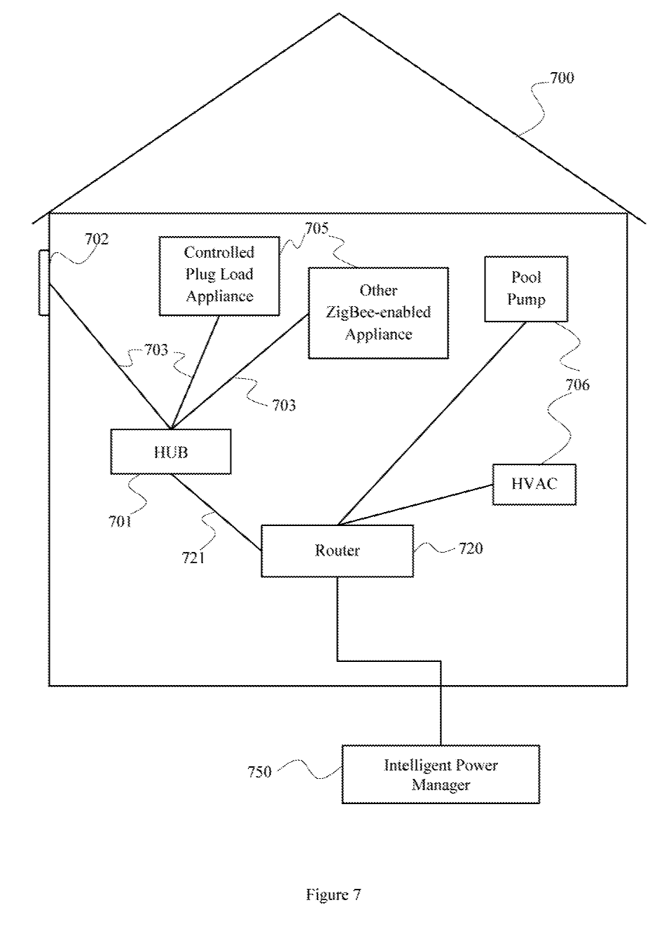

FIG. 7 then depicts a household 700 having a household energy monitoring hub 701. The hub 701 is adapted to receive data describing the energy use of the household 700 and of household appliances 705, 706. The hub 701 receives data from, and optionally controls some functions of at least some household appliances. In order to do this, the hub 701 requires data communication with the household appliances. The hub 701 may also be in data communication with a device which is able to measure the electricity consumption of the household in real time or with a high degree of granularity. Preferably, this device is a Smartmeter 702. The Smartmeter 702 is a device which measures the electricity consumption of the household for billing purposes. The Smartmeter 702 is able to communicate this metering data to the household's energy retailer for billing purposes, but may also communicate the data to the hub 701.

In FIG. 7, the Smartmeter 702 and some appliances 705 are in data communication with the hub 701 via direct wireless links 703. These wireless links 703 may use the ZigBee protocol, but any suitable wired or wireless protocol which is implemented by the appliances 705 and the hub 701 may be used.

Other appliances 706 may not have the appropriate direct connection technology, but will include generic wi-fi capability. These devices 706 are connected to a household wi-fi network created by router 720.

In FIG. 7, particular appliances are shown to be connected to the hub 701 either directly or via the wi-fi router 720. This is not intended as a restriction, and alternatives to the version of FIG. 7, any appliance with suitable capability may be connected to the hub 701 directly or via the router 720, or via both.

The hub 701 is also in data communication with a remote Intelligent Power Manager (IPM) 750 via an internet connection provided by the router 720. The IPM 750 is a remote computer processor which may be in communication with multiple hubs 701 situated at multiple households. The IPM 750 is able to record and analyze data on electricity consumption (and where available, individual appliance electricity consumption), from multiple households, preferably a large number of households. Data from the Smartmeter 702 and from the connected appliances 705, 706 are made available to the IPM 750 via the internet connection provided by the router 720.

In order to communicate with the router 720, and hence with appliances 706 and IPM 750, it is necessary for the hub 701 to establish a wi-fi connection 721 to the router 720. In general, the router 720 will create a wi-fi network which is secured, requiring the hub 701 to have a password to connect to the router 720. The hub 701 does not have a physical user interface to facilitate the entry of a password by a user.

In order to connect to the secured network, the hub 701 requires configuration data for the secured network. This configuration data may include, without limitation, the SSID of the secured network, the security protocol used by the secured network, and a password which will be recognised by the secured network as permitting connection to the secured network. This configuration data is available from a user who has access to a computing device having a user interface and a wi-fi connection capability.

When the hub 701 is first installed in a household, the hub 701 creates an unsecured network. This unsecured network has a predefined configuration which is publicly known. The information is provided as part of the setup instructions for the hub 701 which are provided to the user at installation.

The SSID of the unsecured network is broadcast. Preferably the SSID is a tag which is easily recognised by a user as being associated with the appliance being connected to the secured network.

A user has a computing device which includes a user interface capable of receiving text input, and which has a wi-fi capability, preferably a PC or tablet computer. A smartphone or other suitable device may be used. The user searches for the known SSID of the unsecured network, and connects to that network. The unsecured network does not require a password, nor is the connection encrypted.

The user then opens a web browser and loads a web page which is served by a web server provided by the hub 701. This page allows the user to supply the configuration data for the secured network provided by the wi-fi router 720. These may include, without limitation, the SSID, the security protocol and a password.

Having received the configuration data, the hub 701 uses the configuration data to attempt to connect to the secured network provided by the wi-fi router 720. The attempt to connect may succeed or it may fail. Failure to connect may be due to a number of reasons, including, without limitation:

a. The requested SSID is not found

b. The security protocol does not match

c. The password is incorrect

d. The router rejects connection attempts for other reasons.

The result of the connection attempt, including any reason for failure, is then provided to the web page being displayed to the user. The user is thus aware of the success or failure of the attempt to connect to the secured network provided by the wi-fi router 720.

Where the attempt to connect to the secured network has failed, the user can be informed of the reason for the failure via the web page. The web page then allows the user the opportunity to correct the configuration data before a further attempt is made to connect to the secured network. For example, where an incorrect password has been supplied, the web page, having informed the user of the reason for the connection failure, will allow the user an opportunity to enter a different password. The modified password will then be passed to the network manager, which will make a further attempt to connect to the secured network. The result of this attempt will then be communicated to the hub 701, and hence to the user via the webpage. This may apply to any element of the configuration data.

When the connection 721 is successfully established, this is notified to the hub 701. The success notification is passed to the user via the web page. Upon successful connection, the web page shows instructions to the user to reconnect the PC (or other computing device) to the secured network provided by the wi-fi router 720, which was dropped when the computing device connected to the unsecured network.

Upon communication of a successful connection, the hub 701, immediately or after a short delay, will close down the unsecured network. In many cases this will be sufficient to cause the PC to reconnect to the secured network provided by the wi-fi router 720. In other cases, the user may follow the previously given instructions to reconnect to the secured network.

The versions of the invention described above are merely exemplary, and the invention is not intended to be limited to these versions. Rather, the scope of rights to the invention is limited only by the claims set out below, and the invention encompasses all different versions that fall literally or equivalently within the scope of these claims.

What is claimed is:

1. A device configured to support a secure wi-fi connection to a secured network and a temporary insecure wi-fi connection to an unsecured network, wherein the unsecured network connection is used to collect configuration data from a user, the configuration data enabling creation of the secured network connection.

2. The device of claim 1 wherein information concerning any failure to create the secured network connection is communicated to the user.

3. The device of claim 1 wherein the device lacks any user interface capable of collecting the configuration data.

4. The device of claim 1 further including a web server, the web server serving a web page which is accessible only from the unsecured network connection.

5. The device of claim 4 wherein the web page is configured to receive the configuration data from the user.

6. The device of claim 4 further including:
a. a network manager configured to attempt to create the secured network connection, and
b. a database configured to store a result of each attempt by the network manager to create the secured network connection,
wherein:
(1) the network manager writes the result to the database, and
(2) the web server makes the result available to the user.

7. The device of claim 1 wherein the configuration data includes:
a. the SSID of the secured network,
b. the security protocol of the secured network, and
c. a valid password for the secured network.

8. The network connected device of claim 1 wherein the device is a household energy monitoring hub.

9. The network connected device of claim 1 wherein the device is a standby power controller.

10. A method for creating a secured network connection between a device and a secured network via wi-fi, wherein:
i. the secured network requires configuration data to permit the secured network connection, and
ii. the device lacks any user interface capable of collecting the configuration data,
the method including the device's performance of the steps of:
a. using a temporary insecure wi-fi connection to serve a web page via an unsecured network, the web page being configured to collect the configuration data;
b. attempting creation of a secure wi-fi connection to the secured network using the configuration data collected via the web page.

11. The method of claim 10 wherein the device is a household energy monitoring hub.

12. The method of claim 10 wherein the device is a standby power controller.

13. The method of claim 10 further including the step of communicating to the user, via the web page, any failed attempt to create a secure wi-fi connection to the secured network.

14. The method of claim 10 wherein the device includes:
a. a network manager configured to attempt creation of the secured network connection, and
b. a database configured to store a result of each attempt by the network manager to create the secured network connection,
the method further including the steps of:
(1) the network manager writing the result to the database, and
(2) the web page making the result available to the user.

15. The method of claim 10 wherein the configuration data includes:
a. the SSID of the secured network,
b. the security protocol of the secured network, and
c. a valid password for the secured network.

16. A method for connecting a first device to a secured network wherein the first device lacks any user interface capable of collecting configuration data needed to permit the secured network connection, the method including the steps of:
a. establishing a temporary unsecured network;
b. connecting to the unsecured network from a second device, the second device having a user interface;
c. collecting configuration data of an existing secured network via the user interface over the unsecured network; and
d. creating a secure connection from the first device to the secured network using the configuration data.

17. The method of claim 16 further including the step of shutting down the temporary unsecured network after the secure connection is created between the first device and the secured network.

18. The method of claim 16 further including the steps of:
a. serving a web page from a web server to the unsecured network, the web page being configured for entry of the configuration data thereon;
b. receiving at the web server the result of each attempt to create the secure connection from the device to the secured network; and
c. reporting the result of each attempt to the user via the web page.
